(19) United States
(12) Patent Application Publication
(10) Pub. No.: US 2005/0100235 A1
(43) Pub. Date: May 12, 2005

(54) System and method for classifying and filtering pixels

(76) Inventors: Hao-Song Kong, Newton, MA (US); Anthony Vetro, Cambridge, MA (US); Huifang Sun, Billerica, MA (US)

Correspondence Address: Patent Department;Mitsubishi Electric Research Laboratories, Inc., 201 Broadway, Cambridge, MA, 02139, US

(21) Appl. No.: 10/703,809

(22) Filed: Nov. 7, 2003

(51) Int. Cl. G06K 9/40; G06K 9/00

(52) U.S. Cl. 382/261; 382/170

(57) ABSTRACT

A method classifies pixels in an image. The image can be a decompressed image that was compressed using a block-based compression process. A filter is applied to each pixel in the image to determine a mean intensity value of the pixel. The mean is used to determine a mean-square intensity for each pixel, which in turn is used to determine a variance of the intensity for each pixel. The mean-square represents an average power of a DC component in the image, and the variance represents an average power of AC frequency components in the image. The pixels are then classified according to the variance as being either smooth, edge, or texture pixels. Blocks in the image can then be classified according to the classified pixels, and blocking artifacts and ringing artifacts in the blocks can then be filtered according to the block classification.

### FIELD OF THE INVENTION

The invention relates generally to image processing, and more particularly to reducing visible artifacts in images reconstructed from compressed images.

### BACKGROUND OF THE INVENTION

Compression is used in many imaging applications, including digital cameras, broadcast TV and DVDs, to increase the number of images that can be stored in a memory or to reduce the transmission bandwidth. If the compression ratio is high, then visible artifacts can result in the decompressed images due to quantization and coefficient truncation side effects. A practical solution filters the decompressed image to suppress the visible artifacts and to guarantee a subjective quality of the decompressed images.

Most video coding standards such as ITU-T H.26x and MPEG-1/2/4 use a block-based process. At high compression ratios, a number of artifacts are visible due to the underlying block-based processing. The most common artifacts are blocking and ringing.

The blocking artifacts appear as grid noise along block boundaries in monotone areas of a decompressed image. Blocking artifacts occur because adjacent blocks are processed independently so that pixels intensities at block boundaries do not line up perfectly after decompression. The ringing artifacts are more pronounced along edges of the decompressed image. This effect, known as Gibb's phenomenon, is caused by truncation of high-frequency coefficients, i.e., the quantization of AC coefficients.

Many methods are known for reducing the visible artifacts in decompressed images and videos. Among these methods are adaptive spatial filtering methods, e.g., Wu, et al., “Adaptive postprocessors with DCT-based block classifications,” IEEE Transactions on Circuits and Systems for Video Technology, Vol. 13, No. 5, May 2003, Gao, et al., “A de-blocking algorithm and a blockiness metric for highly compressed images,” IEEE Transactions on Circuits and Systems for Video Technology, Vol. 12, No. 5, December 2002, U.S. Pat. No. 6,539,060, “Image data post-processing method for reducing quantization effect, apparatus therefor,” issued to Lee et al. on Mar. 25, 2003, U.S. Pat. No. 6,496,605, “Block deformation removing filter, image processing apparatus using the same, method of filtering image signal, and storage medium for storing software therefor,” issued to Osa on Dec. 17, 2002, U.S. Pat. No. 6,320,905, “Postprocessing system for removing blocking artifacts in block-based codecs,” issued to Konstantinides on Nov. 20, 2001, U.S. Pat. No. 6,178,205, “Video postfiltering with motion-compensated temporal filtering and/or spatial-adaptive filtering,” issued to Cheung et al. on Jan. 23, 2001, U.S. Pat. No. 6,167,157, “Method of reducing quantization noise generated during a decoding process of image data and device for decoding image data,” issued to Sugahara et al. on Dec. 26, 2000, U.S. Pat. No. 5,920,356, “Coding parameter adaptive transform artifact reduction process,” issued to Gupta et al. on Jul. 6, 1999; wavelet-based filtering methods, e.g., Xiong, et al., “A deblocking algorithm for JPEG compressed images using overcomplete wavelet representations,” IEEE Transactions on Circuits and Systems for Video Technology, Vol. 7, No. 2, August 1997, Lang, et al., “Noise reduction using an undercimated discrete wavelet transform,” Signal Processing Newsletters, Vol. 13, January 1996; DCT-domain methods, e.g., Triantafyllidis, et al., “Blocing artifact detection and reduction in compressed data,” IEEE Transactions on Circuits and Systems for Video Technology, Vol. 12, October 2002, Chen, et al., “Adaptive post-filtering of transform coefficients for the reduction of blocking artifacts,” IEEE Transactions on Circuits and Systems for Video Technology, Vol. 11, May 2001, statistical methods based on MRF models, e.g., Meier, et al., “Reduction of blocking artifacts in image and video coding,” IEEE Transactions on Circuits and Systems for Video Technology, Vol. 9, April 1999, Luo, et al., “Artifact reduction in low bit rate DCT-based image compression,” IEEE Transactions on Image Processing, Vol. 5, September 1996; and iterative methods, e.g., Paek, et al., “A DCT-based spatially adaptive post-processing technique to reduce the blocking artifacts in transform coded images,” IEEE Transactions on Circuits and Systems for Video Technology, Vol. 10, February 2000, and Paek, et al., “On the POCS-based post-processing technique to reduce the blocking artifacts in transform coded images,” IEEE Transactions on Circuits and Systems for Video Technology, Vol. 8, June 1998.

FIG. 1 shows a typical prior art method for processing a compressed image. The method operates first in a decoder 102 and second in a filter 103. A compressed image 101 is variable length decoded (VLD) 110, inverse quantized (Q⁻¹) 120 to obtain DCT coefficients 121, which are used by the filter 130. An inverse DCT (IDCT) 140 is applied to the DCTs to obtain a decompressed image 104, which is fed to the filtering process 130 to produce a processed image 109. A reference frame 142 is used for motion compensation 150. Motion vectors are added 160 to the output of the IDCT 140 to produce the decompressed image 104. The VLD 110 also supplies quantization parameters 111 to the filtering step 130.

It is well known that the human visual system is very sensitive to high frequency (AC) visual changes, such as occur at edges in an image. However, the above method treats all pixels in the compressed image equally. Therefore, the processed image 109 tends to be blurry, or some of the artifacts remain. Some methods filter adaptively but cannot handle different artifacts.

All prior art methods tend to be computationally complex. For example, wavelet-based methods apply eight low-pass and high-pass convoluted filtering operations on the wavelet image. Then, a de-blocking operation is performed to obtain a de-blocked image. To reconstruct the de-blocked image, twelve convolution-based low-pass and high-pass filtering operations are required. A total of twenty convolution-based filters have to be applied to the input image to produce the processed image. The computational cost of that method makes it impractical for real-time applications.

Similar to the wavelet-based method, a DCT-domain method also has high computational complexity. For a 5×5 low-pass filtering operation, 25 DCT transforms are required for processing a single 8×8 block. Such high complexity is highly impractical. The complexity of iterative methods is even higher than the above wavelet and DCT methods.

All of the above methods rely either on quantization parameters in the compressed image as their threshold to filter out the artifacts, or use DCT coefficients of the compressed image to extract features of the artifacts. Because both quantization parameters and DCT coefficients are embedded in the compressed image, outputs of the decoding operation must be available before the artifacts can be filtered.

In view of the above problems, there is a need for a method for reducing artifacts in a decompressed image that has low complexity and does not rely on any decompression parameters embedded in the compressed image.

### SUMMARY OF THE INVENTION

A method classifies pixels in an image. The image can be a decompressed image that was compressed using a block-based compression process. A 3×3 smooth filter is applied to each pixel in the image to determine a mean intensity value of the pixel.

The mean is used to determine a mean-square intensity for each pixel, which in turn is used to determine a variance of the intensity for each pixel. The mean-square represents an average power of a DC component in the image, and the variance represents an average power of AC frequency components in the image.

The pixels are then classified according to the variance as being either smooth, edge, or texture pixels. Blocks in the image are classified according to the classified pixels.

Then, blocking artifacts and ringing artifacts in the blocks, due to the prior compression, can then be filtered according to the block classification.

### BRIEF DESCRIPTION OF THE DRAWINGS

FIG. 1 is a block diagram of a prior art method for decoding a compressed image and filtering the decoded image;

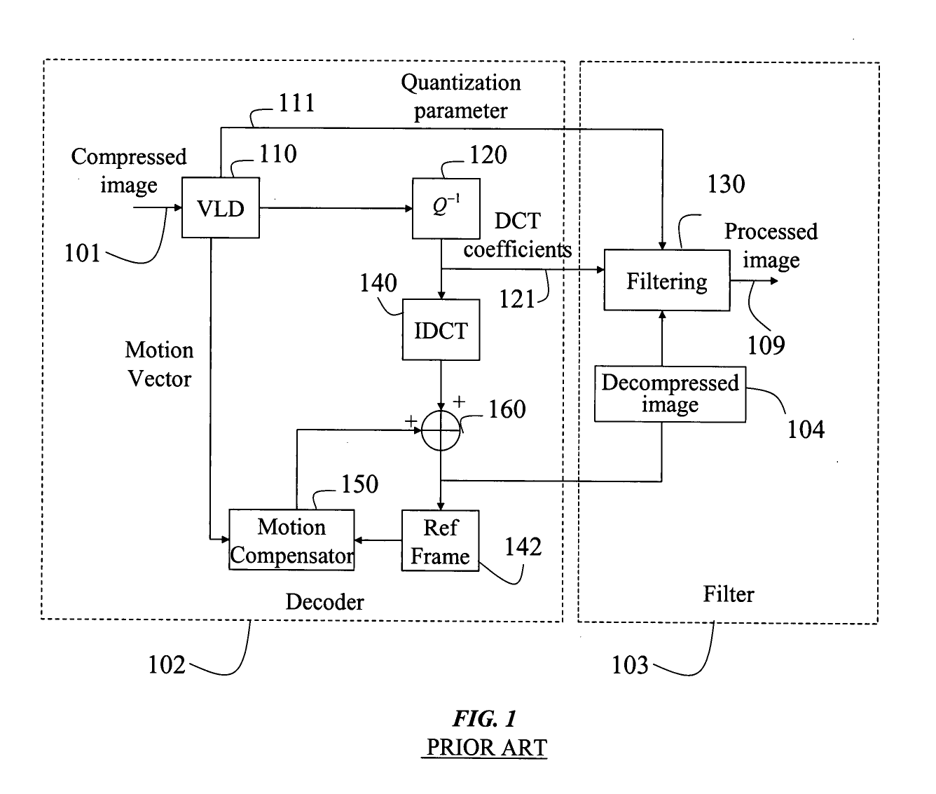

FIG. 2 is a block diagram of a system and method for filtering a decompressed image according to the invention;

FIG. 3 is a block diagram of feature extraction according to the invention;

FIG. 4 is a block diagram of mapping between an intensity image and a variance according to the invention;

FIG. 5 is a block diagram for classifying pixels according to the invention;

FIG. 6 is a block diagram for detecting blocking artifacts according to the invention;

FIG. 7 is a block diagram for filtering blocking artifacts according to the invention; and

FIG. 8 is a block diagram for filtering ringing artifacts according to the invention.

### DETAILED DESCRIPTION OF THE PREFERRED EMBODIMENT

Our invention provides a system and method for filtering a decompressed image to reduce blocking artifacts and ringing artifacts. In contrast with the prior art, we classify the artifacts in the decompressed image and filter the decompressed image according to the classification. In addition, our method does not require any parameters related to the compressed image, as in the prior art.

From a perspective of the human visual system, each pixel serves a different role in an image. Because the human visual system is very sensitive to high frequency changes, especially to edges in an image, edges are very important to our perception of the image. Therefore, our strategy is to classify the pixels in the compressed before filtering. If we know the location of edges, then we can avoid filtering the pixels related to edges, while still filtering other pixels.

System Structure and Method Operation

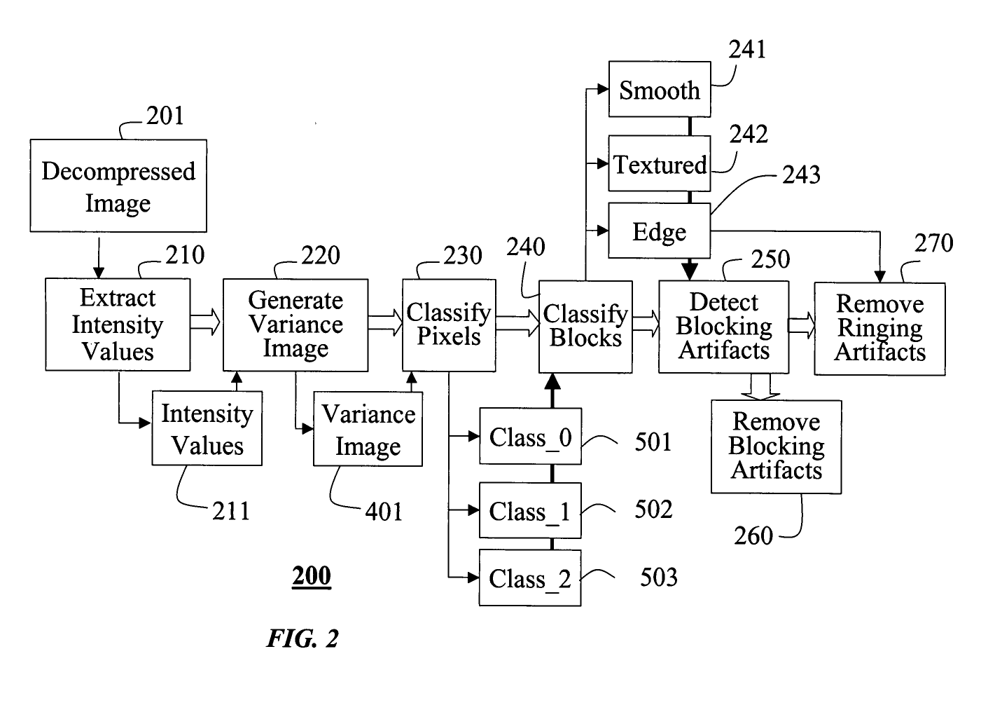

FIG. 2 shows the system and method 200 according to the invention. This system is independent of any image or video decoder. The system does not rely on any coding parameters embedded in a compressed image or video. The emphasis of our method is on local features in an image. The method according to the invention extracts local features, which are classified. The classified features can then be used to filter selectively and adaptively the pixels, if the image is a decompressed image.

The input is a decompressed image 201. The method works for any image format, e.g., YUV or RGB. It should be understood that the system can handle a sequence of images as in a video. For example, the image 201 can be part of a progressive or interlaced video. It should also be noted that input image can be a source image that has never been compressed.

However, if the input image is a decompressed image derived from a compressed image, and the compressed image was derived from a source image compressed with a block-based compression process, then due to prior compression, the decompressed image 201 has blocking artifacts caused by independent quantization of DCT coefficients blocks of the compressed image. Therefore, the decompressed image 201 has block discontinuities in spatial values between adjacent blocks. Ringing artifacts are also possible along edges in the decompressed image.

In order to reduce these artifacts while preserving the original texture and edge information, the filtering according to the invention is based on a classification of local features in the decompressed image.

Variance Image

From a statistical perspective, a distribution of intensity values of the pixels reveal features of the decompressed image. A mean intensity value m of the image represents the DC component of the image. The mean intensity value can be measured by

$$m = E \{ x [ i , j ] \} = {\sum }_{i = 0}^{M} {\sum }_{j = 0}^{N} {x}_{i , j} {p}_{{x}_{i , j}} , \qquad ( 1 )$$

where M and N are a width and height of the decompressed image in terms of pixels, and pₓ_{_{i,j}} is a probability of a pixel occurred at a location of i, j.

An average power of the decompressed image is a mean-square value

$$\overline{{m}^{2}} = E \{ {x [ i , j ]}^{2} \} = {\sum }_{i = 0}^{M} {\sum }_{j = 0}^{N} {x}_{i , j}^{2} {p}_{{x}_{i , j}} . \qquad ( 2 )$$

A fluctuations about the mean is the variance

$${σ}^{2} = E \{ {( x [ i , j ] - m )}^{2} \} = {\sum }_{i = 0}^{M} {\sum }_{j = 0}^{N} {( {x}_{i , j} - m )}^{2} {p}_{{x}_{i , j}} = {\sum }_{i = 0}^{M} {\sum }_{j = 0}^{N} {x}_{i , j}^{2} {p}_{{x}_{i , j}} - {m}^{2} . \qquad ( 3 )$$

The mean-square represents an average power of the DC component in the image, and the variance represents an average power of the AC frequency components in the compressed image 201. Therefore, the variance of the intensity values are used as a measure of a fluctuation of AC power, which represents the energy in the image.

If the variance is high for a pixel, than the pixel is likely to be associated with an edge. If the variance is low, the pixel is part of a homogeneous region of the image, for example, a smooth background. Thus, the variance reveals characteristics of local features in the image.

Because both the blocking artifacts and the ringing artifacts are due to the local characteristics of features, i.e., the artifacts appear either on block boundaries or near the edges, the local features are sufficient to reveal these artifacts. Therefore, the classification and filtering according to the invention are based on the energy distribution as measured by the local variance of pixel intensity values, as stated in Equation (3) above. The feature characteristics are determined by extracting 210 intensity values 211 as follows.

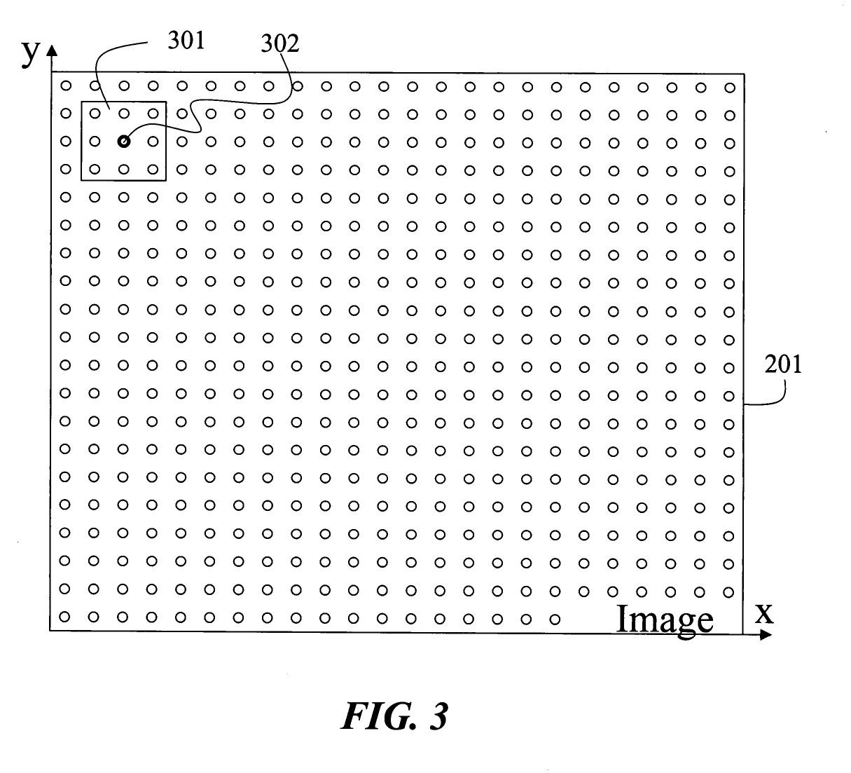

As shown in FIG. 3, a smooth 3×3 filter 301 is scanned over each pixel 302 in a decompressed image 201. The scanning can be in raster scan order. The mean and the variance of the intensity values 211 are determined 220 for each central pixel 301 of the filter according to equations 1-3. The variance form a variance image 401. From a geometry viewpoint, the local variance reflects a gradient of the decompressed image at each pixel location.

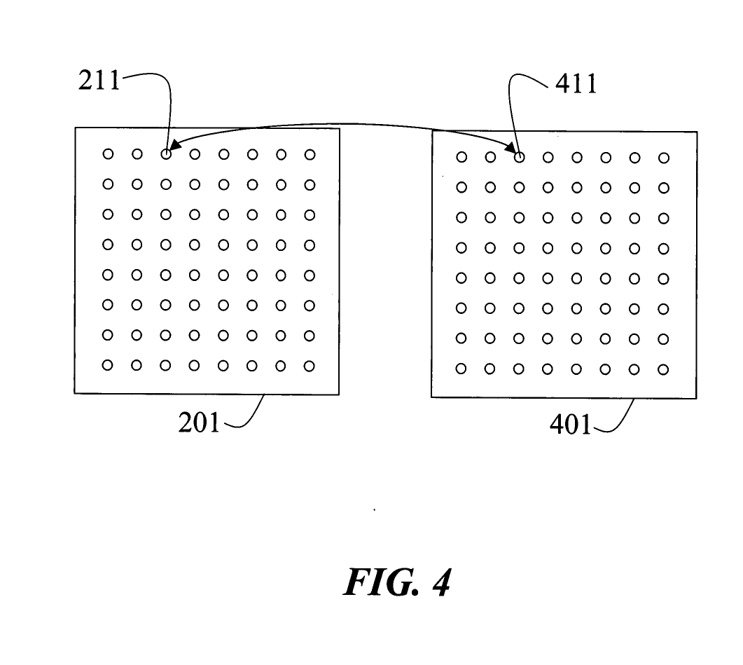

As shown in FIG. 4, the feature extraction and scanning transforms the decompressed image 201 from the spatial domain where the pixels have intensity values 211 to the variance image 401 in the energy domain where the pixels have variances 411.

Pixel Classification

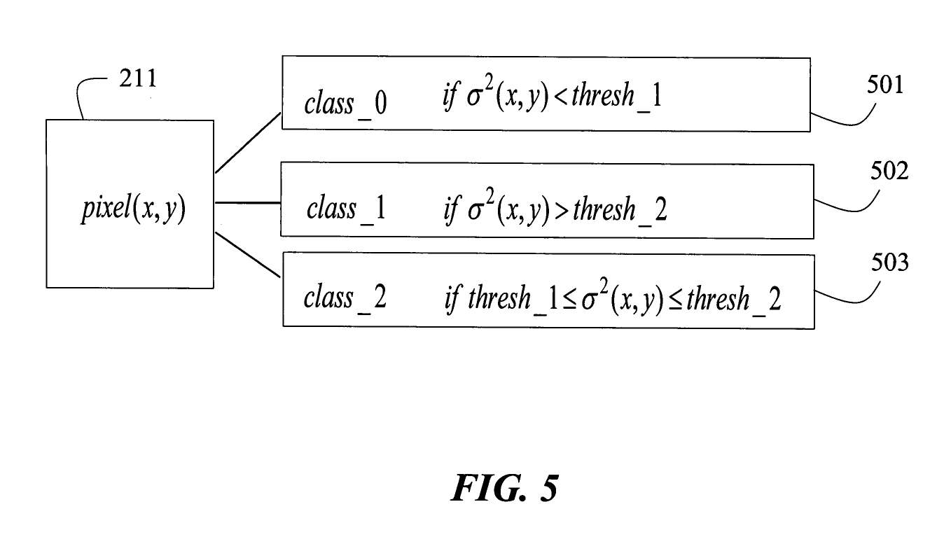

As shown in FIG. 5, pixels 211 with variances less than a first threshold_1 are classified as class_0 501. These pixels correspond to homogeneous or ‘smooth’ regions in the image. Pixel with variances greater than a second threshold_2 are classified as class_1 502. These pixels most likely correspond to edges. Pixels with variances between these two thresholds are classified as class_2 503. These pixels can be considered as either ringing noise or texture depending on the characteristics of neighboring pixels. The adaptive filtering according to the invention is performed according to the above classifications.

Block Classification

10441 Blocks of pixels are also classified 240 in into ‘smooth’ 241, ‘textured’ 242 and ‘edge’ 243 blocks according to the variance values in the edge map 220. The block classification 240 can be based on the total variance within each block or by counting the number of pixels of each class in the block. For example, if all the pixels in the block are class_0, then the block is the block is classified as smooth. If at least one pixel in the block is class_1, then the block is classified as an edge block. Otherwise, if the block has both class_0 and class_{—}2 pixels, then the block is classified as a texture block.

Blocking Artifact Detection

Most recognized standards for compressing images and videos use are based on DCT coding of blocks of pixels. Block-based coding fully partitions the image into blocks of pixels, typically 8×8 pixels per block. The pixels of each block are transformed independently to DCT coefficients. Then, the DCT coefficients are quantized according to a pre-determined quantization matrix. Due to the independent coding, the blocking artifacts are visible at the block boundaries.

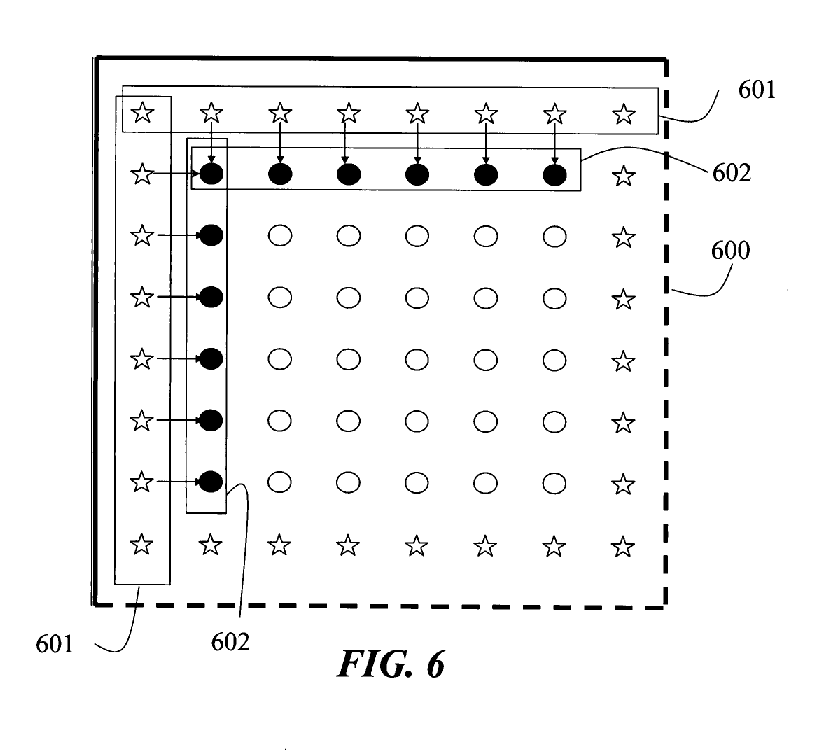

FIG. 6 shows how blocking artifacts are detected 250 on an 8×8 block 600. Outer pixels are denoted by stars 601, and ‘inner’ pixels by black circles 602. The inner pixels are located adjacent and parallel to the top row and left column in the block. The detection 250 is performed from left to right and top to bottom for each block.

The gradients of the variances of the outer pixels 601 are most like the inner pixels 602 when blocking artifacts exist. The criterion for deciding that blocking artifact are present is

$$\vert {\sum }_{i = 1}^{6} sign {(*}_{i} - {\cdot }_{i} ) \vert \geq 5 \qquad ( 4 )$$

sign is either +1 or −1. The above test distinguishes between blocking artifacts and edges on block boundaries.

Deblocking Filter

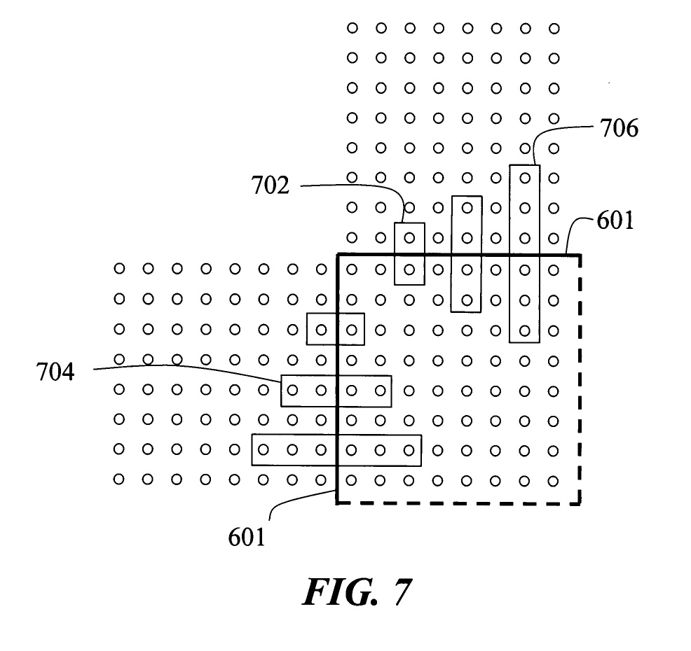

As shown in FIG. 7, the blocking artifacts are removed by filtering detected block boundaries in the decompressed image. If a blocking artifact is detected, a one-dimensional low-pass (smoothing) filter is adaptively applied to pixels along block boundaries 601. Sizes of the filters 702, 704, 706, e.g., two, four, six or more pixels, correspond to the gradients at the block boundaries. Pixels with large gradient values, i.e., edge pixels, are excluded from the filtering operation to avoid blurring edges or textures.

Deringing Filter

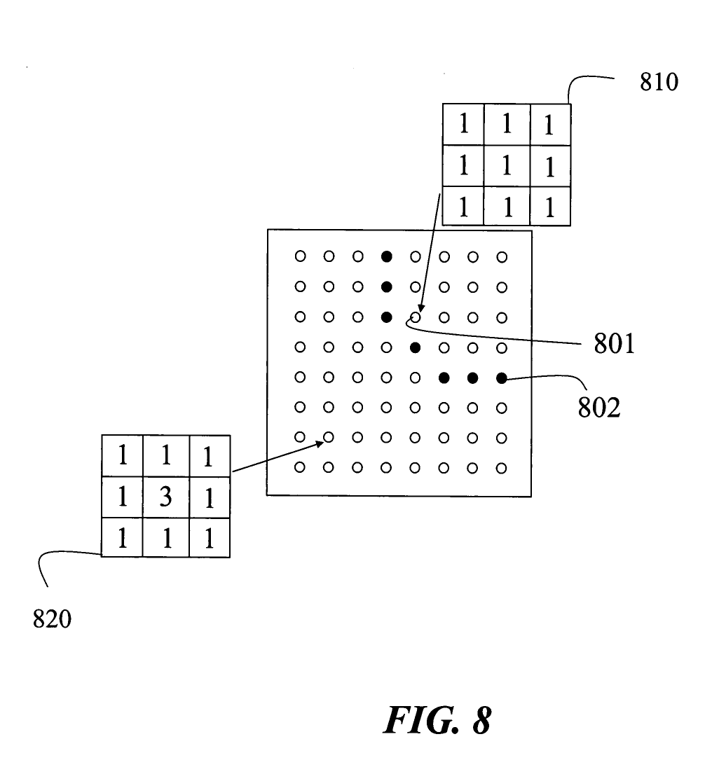

As shown in FIG. 8, the deringing 270 operates only on edge blocks 243. A smooth (1/9), adaptive 3×3 low pass filter 810 is applied to (white) pixels 801 adjacent to (black) edge pixels 802. A uneven (1/11) filter 820 with a large central weight (3) is applied to texture pixels 803 far away from the edges to preserve details, e.g., more than three pixels away. Because the de-ringing operation is guided by the variance image and because edge filters are not filtered, the edges in the decompressed image remain unchanged.

It is to be understood that various other adaptations and modifications may be made within the spirit and scope of the invention. Therefore, it is the object of the appended claims to cover all such variations and modifications as come within the true spirit and scope of the invention.

1. A method for classifying pixels in an image, comprising:
applying a filter to each pixel in the image to determine a mean intensity value;
determining a mean intensity for each filtered pixel;
determining a mean-square intensity for each pixel from the mean intensity;
determining a variance of the intensity for each pixel from the mean square intensity; and
classifying a particular pixel as smooth pixel if the variance is below a first threshold, as an edge pixel if the variance is greater than a second threshold, and as a texture pixel otherwise.

2. The method of claim 1, in which the mean-square represents an average power of a DC component in the image, and the variance represents an average power of AC frequency components in the image.

3. The method of claim 1, in which the filter is a smooth 3×3 filter with the particular pixels is in the middle of the filter, and further comprising:
scanning the filter in a raster scan order over the image.

4. The method of claim 1, in which the image is a decompressed image derived from a compresses image, and the compressed image was derived from a source image compressed with a block-based compression process.

5. The method of claim 1, further comprising:
partitioning the image into a plurality of blocks; and
classifying each block according to the classified pixels.

6. The method of claim 1, in which a particular block is classified as a smooth block if all pixels in the particular block as classified as smooth, as an edge block if at least one pixel in the block is classified as edge, and as a texture block otherwise.

7. The method of claim 6, further comprising:
detecting if a particular block includes blocking artifacts based on the classified pixels; and
filtering the blocking artifacts.

8. The method of claim 7, further compromising:
detecting edge pixels in the particular block;
filtering pixels adjacent to the edge pixels with a smooth filter, and filtering other pixels than edge pixels and adjacent pixels with an uneven filter to remove ringing artifacts.
